(19) United States
(12) Patent Application Publication
(10) Pub. No.: US 2025/0231720 A1
(43) Pub. Date: Jul. 17, 2025

(54) IMAGE PROCESSING APPARATUS, TERMINAL APPARATUS, PROGRAM, AND PRINTING SYSTEM

(71) Applicant: KYOCERA CORPORATION, Kyoto-shi (JP)

(72) Inventors: Naoki KOBAYASHI, Kirishima-shi (JP); Hiroshi OKA, Kyoto-shi (JP); Shigeki TAKAYA, Yokohama-shi (JP); Masatoshi GO, Kirishima-shi (JP)

(21) Appl. No.: 19/098,996

(22) Filed: Apr. 3, 2025

Related U.S. Application Data
(63) Continuation of application No. PCT/JP2023/036074, filed on Oct. 3, 2023.

(30) Foreign Application Priority Data
Oct. 4, 2022 (WO) PCT/JP2022/037177

(51) Int. Cl. G06F 3/12; B41J 29/393; G03G 15/00; G03G 21/16

(52) U.S. Cl. CPC G06F 3/1204; B41J 29/393; G03G 15/5066; G03G 15/5087; G03G 21/1657; G06F 3/1236; G06F 3/1247; G06F 3/126; G06F 3/1292

(57) ABSTRACT

An image processing apparatus includes a storage, a communicator, an image processor, a controller, a housing, the communicator, the image processor, and the controller, and a mount mechanism. When the controller receives a print operation from a user while the terminal apparatus is mounted on the mount mechanism: the controller causes the image processor to perform printing by the communicator receiving print data from the terminal apparatus when a second file the same as the first file is not saved in the storage, the print data being acquired by converting the first file into a data format suitable for printing; and the controller causes the image processor to perform printing by the communicator receiving, from the terminal apparatus, a print instruction for instructing to print the second file instead of receiving the print data when the second file is saved in the storage.

### RELATED APPLICATIONS

The present application is a continuation based on PCT Application No. PCT/JP2023/036074, filed on Oct. 3, 2023, which claims the benefit of WO Application No. PCT/JP2022/037177 filed on Oct. 4, 2022. The content of which is incorporated by reference herein in their entirety.

### TECHNICAL FIELD

The present disclosure relates to an image processing apparatus, a terminal apparatus, a program, and a printing system.

### BACKGROUND

An image processing apparatus such as a printer generally includes a display that displays an image including various types of information. The display of the image processing apparatus is lower in resolution, lower in refresh rate, and/or smaller in size than a display of the terminal apparatus such as a smartphone or a tablet terminal. Therefore, operability of the image processing apparatus is often lower than that of the terminal apparatus.

In recent years, a printing system has been achieved which causes a terminal apparatus to display an operation screen for an image processing apparatus, and the terminal apparatus operates the image processing apparatus through wireless communication between the image processing apparatus and the terminal apparatus. Such an image processing apparatus may be configured to include a small size display that is as small as possible to display a two-dimensional code. Alternatively, such an image processing apparatus may be configured not to include a display (panelless).

### CITATION LIST

### Patent Literature

Patent Document 1: JP 2021-9467 A
Patent Document 2: JP 2021-22123 A

### SUMMARY

According to a first aspect of the present disclosure, an image processing apparatus includes a storage, a communicator communicably connected to a terminal apparatus saving one or more files, an image processor performing image processing including printing, a controller controlling the image processor based on communication of the communicator, a housing provided with the storage, the communicator, the image processor, and the controller, and a mount mechanism mounting the terminal apparatus on the housing. When the controller receives a print operation for a first file saved in the terminal apparatus from a user while the terminal apparatus is mounted on the mount mechanism: the controller causes the image processor to perform printing by the communicator receiving print data from the terminal apparatus when a second file the same as the first file is not saved in the storage, the print data being acquired by converting the first file into a data format suitable for printing; and the controller causes the image processor to perform printing by the communicator receiving, from the terminal apparatus, a print instruction for instructing to print the second file instead of receiving the print data when the second file is saved in the storage.

According to a second aspect of the present disclosure, a terminal apparatus includes a storage configured to save one or more files, a communicator configured to be communicably connected to an image processing apparatus configured to perform image processing and including a housing including a mount mechanism configured to mount a terminal apparatus, a display configured to display an operation screen for operating the image processing apparatus, an operation inputter configured to receive an operation on the operation screen for printing a file selected by a user from among the one or more files, and a controller configured to control the communicator to communicate with the image processing apparatus. When the controller receives a print operation for a first file saved in the storage from the user while the terminal apparatus is mounted on the mount mechanism: the controller causes the image processing apparatus to perform printing by transmitting print data to the image processing apparatus via the communicator when a second file the same as the first file is not saved at the image processing apparatus side, the print data being acquired by converting the first file into a data format suitable for printing; and the controller causes the image processing apparatus to perform printing by the communicator transmitting, to the image processing apparatus, a print instruction for instructing to print the second file instead of transmitting the print data, when the second file is saved at the image processing apparatus side.

According to a third aspect of the present disclosure, a program causes a terminal apparatus to perform: saving one or more files in a storage; communicating with an image processing apparatus configured to perform image processing and including a housing including a mount mechanism configured to mount a terminal apparatus; displaying an operation screen for operating the image processing apparatus; receiving an operation on the operation screen for printing a file selected by a user from among the one or more files; and when receiving a print operation for a first file saved in the storage from the user while the terminal apparatus is mounted on the mount mechanism: causing the image processing apparatus to perform printing by transmitting print data to the image processing apparatus when a second file the same as the first file is not saved at the image processing apparatus side, the print data being acquired by converting the first file into a data format suitable for printing; and causing the image processing apparatus to perform printing by transmitting, to the image processing apparatus, a print instruction for instructing to print the second file instead of transmitting the print data when the second file is saved at the image processing apparatus side.

According to a fourth aspect of the present disclosure, a printing system includes the image processing apparatus according to the first aspect and the terminal apparatus according to the second aspect.

According to a fifth aspect of the present disclosure, an image processing apparatus includes a storage configured to save files, a communicator configured to be communicably connected to a terminal apparatus saving files, an image processor configured to perform image processing including printing, a controller configured to control the image processor based on communication of the communicator, a housing provided with the storage, the communicator, the image processor, and the controller, and a mount mechanism configured to mount the terminal apparatus on the housing. When the controller receives a print operation for a target file from a user of the terminal apparatus while the terminal apparatus is mounted on the housing: the controller causes the image processor to perform printing by the communicator receiving print data from the terminal apparatus when the target is saved in the terminal apparatus, the print data being acquired by converting the target file into a data format suitable for printing, and the controller causes the image processor to perform printing by receiving, from the terminal apparatus, a print instruction for instructing to print the target file instead of receiving the print data when the target file is saved in the storage.

### BRIEF DESCRIPTION OF THE DRAWINGS

FIG. 1 is a diagram illustrating a configuration example of a printing system according to an embodiment.

FIG. 2 is a diagram illustrating a configuration example of a terminal apparatus according to the embodiment.

FIG. 3 is a diagram illustrating a configuration example of an image processing apparatus according to the embodiment.

FIG. 4 is a diagram illustrating an outer appearance configuration example of the image processing apparatus according to the embodiment.

FIG. 5 is a diagram illustrating an example of a mount mechanism via which the terminal apparatus is leaned against the image processing apparatus according to the embodiment.

FIG. 6 is a diagram illustrating an example of the mount mechanism via which the terminal apparatus is held vertically against the image processing apparatus according to the embodiment.

FIG. 7 is a diagram illustrating an example of the mount mechanism via which the terminal apparatus is held horizontally against the image processing apparatus according to the embodiment.

FIG. 8 is a diagram illustrating an example of folders created for each user in the image processing apparatus according to the embodiment.

FIG. 9 is a diagram illustrating an operation example of the printing system according to the embodiment.

FIG. 10 is a diagram illustrating a displaying example of an operation screen in the terminal apparatus according to the embodiment.

FIG. 11 is a diagram illustrating a displaying example of the operation screen in the terminal apparatus according to the embodiment.

FIG. 12 is a diagram illustrating a displaying example of the operation screen in the terminal apparatus according to the embodiment.

FIG. 13 is a diagram illustrating a displaying example of the operation screen in the terminal apparatus according to the embodiment.

FIG. 14 is a diagram illustrating an example of processing of synchronization between the image processing apparatus and the terminal apparatus according to the embodiment.

FIG. 15 is a diagram for illustrating a first variation of an operation according to the embodiment.

FIG. 16 is a diagram illustrating a second variation of the operation according to the embodiment.

FIG. 17 is a diagram illustrating a third variation of the operation according to the embodiment.

### DESCRIPTION OF EMBODIMENTS

A printing system is described according to an embodiment with reference to the drawings. In the description of the drawings, the same or similar parts are denoted by the same or similar reference signs.

### Overview of Embodiment

In a printing system of related art in which a terminal apparatus operates an image processing apparatus through wireless communication between the terminal apparatus and the image processing apparatus, a problem is that a prior setting work is required for establishing a communication connection of wireless communication, which is troublesome for a user. Although the user at a location away from the image processing apparatus can perform a print operation by the terminal apparatus instructing the image processing apparatus to perform printing by the image processing apparatus through wireless communication, there is also a concern that another user carries away a printed sheet (document).

Further, assume that the user performs an operation of printing a file saved in the terminal apparatus by the image processing apparatus. Each time such printing is performed, the terminal apparatus may convert a file to be printed into a data format suitable for printing to generate print data, and transmit the print data to the image processing apparatus. Therefore, for example, when a communication band between the terminal apparatus and the image processing apparatus is narrow, a transfer time of the print data becomes long, and a long time is required until printing is completed. This impairs convenience of the user, which is a problem.

The present embodiment provides a printing system capable of enhancing user's convenience.

According to the present embodiment, an image processing apparatus includes a storage, a communicator communicably connected to a terminal apparatus saving one or more files, an image processor performing image processing including printing, a controller controlling the image processor based on communication of the communicator, a housing provided with the storage, the communicator, the image processor, and the controller, and a mount mechanism mounting the terminal apparatus on the housing. When the controller receives a print instruction for a first file saved in the terminal apparatus from a user while the terminal apparatus is mounted on the mount mechanism, when a second file the same as the first file is not saved in the storage, the controller causes the image processor to perform printing by the communicator receiving print data from the terminal apparatus, the print data being acquired by converting the first file into a data format suitable for printing, and when the second file is saved in the storage, the controller causes the image processor to perform printing by the communicator receiving a print instruction for instructing to print the second file, instead of receiving the print data, from the terminal apparatus.

According to the present embodiment, a terminal apparatus includes a storage configured to save one or more files, a communicator configured to be communicably connected to an image processing apparatus configured to perform image processing and including a housing including a mount mechanism configured to mount a terminal apparatus, a display configured to display an operation screen for operating the image processing apparatus, an operation inputter configured to receive an operation on the operation screen for printing a file selected by a user from among the one or more files, and a controller configured to control the communicator to communicate with the image processing apparatus. When the controller receives a print instruction for a first file saved in the storage from the user while the terminal apparatus is mounted on the mount mechanism, when a second file the same as the first file is not saved on a side of the image processing apparatus, the controller causes the image processing apparatus to perform printing by transmitting print data to the image processing apparatus via the communicator, the print data being acquired by converting the first file into a data format suitable for printing, and when the second file is saved on the side of the image processing apparatus, the controller causes the image processing apparatus to perform printing by the communicator transmitting a print instruction for instructing to print the second file, instead of transmitting the print data, to the image processing apparatus.

As described above, according to the present embodiment, the image processing apparatus includes the mount mechanism that mounts the terminal apparatus on the housing. This makes it easier for the terminal apparatus to be connected to the image processing apparatus by means of a physical connection, for example, a mechanical connection, and to establish a communication connection by means of the mechanical connection. The print instruction being given while the terminal apparatus is mechanically connected to the image processing apparatus can ensure that the user is in the vicinity of the image processing apparatus, and eliminate a concern that another user carries away a printed sheet (document). Further, when a file the same as the file to be printed selected by the user is saved at the image processing apparatus side, the terminal apparatus transmits a print instruction for instructing to print the file, instead of transmitting the print data, to the image processing apparatus. This makes it possible to shorten the time until the printing is completed compared to the transmitting of the print data, and improve convenience for the user.

### (Example System Configuration)

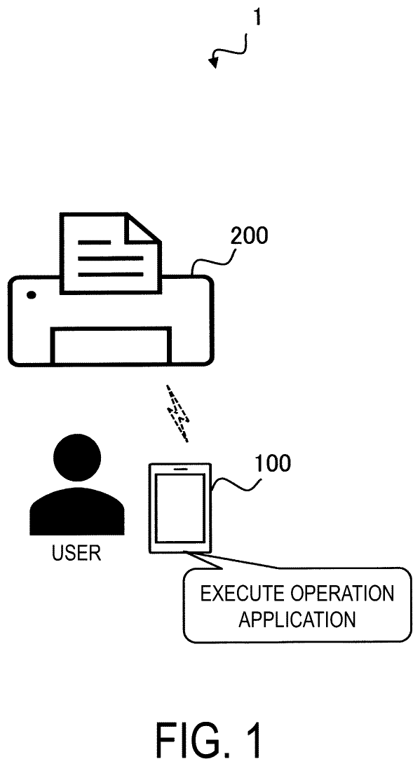

FIG. 1 is a diagram illustrating a configuration example of a printing system 1 according to the present embodiment. The printing system 1 includes a terminal apparatus 100 and an image processing apparatus 200. Although one terminal apparatus 100 is illustrated in the illustrated example, the number of terminal apparatuses 100 may be two or more.

The terminal apparatus 100 is an apparatus performing wireless communication. The terminal apparatus 100 may be a mobile terminal, for example, a smartphone, a tablet terminal, a laptop computer (PC), or the like. In the present embodiment, assume that the terminal apparatus 100 is a mobile terminal that moves along with movement of the user. However, the terminal apparatus 100 may be an operation terminal used to be dedicated to an operation of the image processing apparatus 200.

The image processing apparatus 200 is an apparatus that performs image processing including printing. The image processing apparatus 200 may be a printer, a copier, or a facsimile machine, or a multifunction printer having these functions. In the present embodiment, the image processing apparatus 200 has a function of performing wireless communication.

In the present embodiment, the image processing apparatus 200 is a panelless image processing apparatus that does not include a display for displaying an image. Alternatively, the image processing apparatus 200 may be configured to include a small size display that is as small as possible to display a two-dimensional code.

The terminal apparatus 100 executes an operation application (also simply referred to as an “application”) for operating the image processing apparatus 200. The terminal apparatus 100 that executes the operation application displays an operation screen for the image processing apparatus 200. The operation screen includes a connection screen used when connecting to the image processing apparatus 200, a menu screen used after connecting to the image processing apparatus 200, a selection screen used to select a target of image processing, and the like. On the menu screen, an operation button for instructing to perform image processing may be displayed for each type of image processing.

The terminal apparatus 100 operates the image processing apparatus 200 through wireless communication with the image processing apparatus 200. In the present embodiment, the terminal apparatus 100 establishes a direct wireless communication connection to the image processing apparatus 200 to perform direct wireless communication with the image processing apparatus 200. Such direct wireless communication may be an ad hoc mode (also referred to as an “access point mode”) of a wireless local area network (LAN) communication scheme. In this case, the image processing apparatus 200 functions as a wireless LAN access point. The wireless LAN communication scheme may be a scheme conforming to the IEEE 802.11 standards. The wireless LAN communication scheme may be referred to as Wi-Fi (trade name). Alternatively, the terminal apparatus 100 may establish an indirect wireless communication connection to the image processing apparatus 200 to perform indirect wireless communication with the image processing apparatus 200.

Alternatively, the direct wireless communication may be wireless communication of a Bluetooth (trade name, hereinafter, also referred to as “BT”) scheme. The direct wireless communication may be wireless communication of a near field communication (NFC) scheme.

The terminal apparatus 100 may be physically connected to the image processing apparatus 200, for example, may be mechanically or electrically connected to the image processing apparatus 200. For example, the terminal apparatus 100 may perform communication of a universal serial bus (USB) scheme with the image processing apparatus 200. Such USB scheme communication (also referred to as “USB communication”) is an example of wired communication. However, the wired communication is not limited to the USB communication, and may be communication according to another wired communication standard. Although details are described later, the terminal apparatus 100 can be mechanically fixed and connected to the image processing apparatus 200. The terminal apparatus 100, when connected to the image processing apparatus 200, may automatically activate the operation application. The terminal apparatus 100 and the image processing apparatus 200, when mechanically connected to each other, may automatically start processing of synchronization. The processing of synchronization is described in detail below.

### Configuration Example of Terminal Apparatus

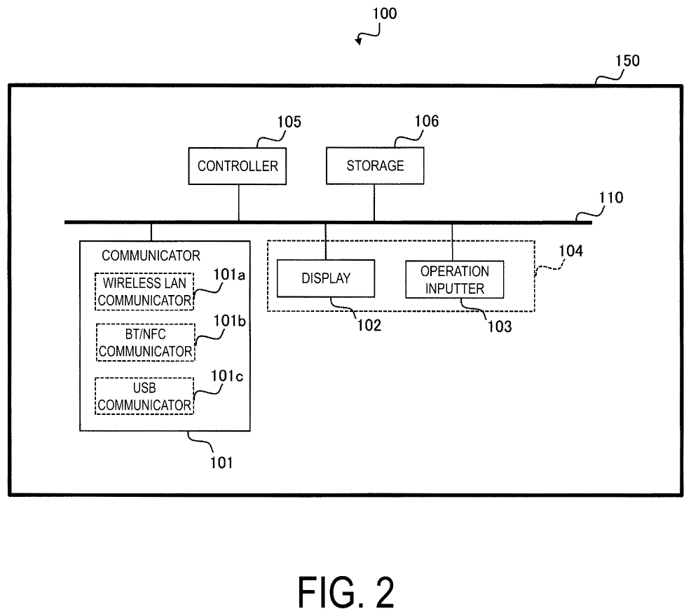

FIG. 2 is a diagram illustrating a configuration example of the terminal apparatus 100 according to the present embodiment.

The terminal apparatus 100 includes a communicator 101, a display 102, an operation inputter 103, a controller 105, and a storage 106. The communicator 101, the display 102, the operation inputter 103, the controller 105, and the storage 106 are electrically connected to each other through a bus 110, for example. An interface may be interposed between the bus 110 and each component. The terminal apparatus 100 may further include a battery, a camera, and the like. The communicator 101, the display 102, the operation inputter 103, the controller 105, and the storage 106 are accommodated in a housing 150 of the terminal apparatus 100.

The communicator 101 performs communication with the image processing apparatus 200. The communicator 101 includes at least one selected from the group consisting of a wireless LAN communicator 101a (first communicator), a BT/NFC communicator 101b (second communicator), and a USB communicator 101c. The wireless LAN communicator 101a performs wireless communication of the wireless LAN communication scheme with the image processing apparatus 200. The BT/NFC communicator 101b performs wireless communication of the BT scheme and/or NFC scheme with the image processing apparatus 200. The USB communicator 101c performs wireless communication of the USB scheme with the image processing apparatus 200. Note that the terminal apparatus 100 may further include a public network communicator that performs communication via a public network. The public network may include a cellular communication network. The public network communicator may be a cellular communicator.

The display 102 displays an image under control of the controller 105. The operation inputter 103 receives a user operation (user input). At least a portion of the operation inputter 103 may be integrated with the display 102 to configure a touch panel display 104. At least a portion of the operation inputter 103 may be configured as one or more physical buttons. The display 102 includes a liquid crystal display or an organic electro luminescence (EL) display. The touch panel constituting the operation inputter 103 detects a position of a touch operation on the display 102 and outputs a detection result.

The controller 105, which includes one or more processors, controls the entire terminal apparatus 100. The controller 105 executes programs stored in the storage 106 to perform various types of processing. The program may include the operation application for operating the image processing apparatus 200. The controller 105 controls each of operations of the communicator 101, the display 102, the operation inputter 103, and the storage 106. Note that the controller 105 may include a logic circuit or the like configured to perform only a certain operation. The operations of the terminal apparatus 100 described above and below may also be operations controlled by the controller 105.

For example, the storage 106 includes various memories such as a Read Only Memory (ROM), a Random Access Memory (RAM), and an auxiliary storage device. A combination of the controller 105 and the storage 106 may be considered as a computer. The program to be executed by the controller 105 is stored in the ROM and/or the auxiliary storage device of the storage 106, for example.

Note that FIG. 2 is merely a schematic view. For example, a number of the controllers 105 and the storages 106 may be provided in a distributed manner. For example, a processor included in each component (a controller that controls each component from another viewpoint) and a higher layer processor (a higher layer controller that controls the controller of each component) may be provided. In such a case, the controller 105 may be considered as the higher layer controller, or may be considered as a combination of the controller of each component and the higher layer controller.

In the terminal apparatus 100 configured as described above, the storage 106 saves one or more files. The file may be an image file, a text file, or an audio file. The storage 106 may include a removable storage medium such as a memory card. The storage 106 may include a local storage (e.g., a network attached storage (NAS)) provided on a LAN.

The communicator 101 is communicably connected to the image processing apparatus 200. The communicable connection may be a state in which at least one selected from the group consisting of the wireless LAN communicator 101a, the BT/NFC communicator 101b, and the USB communicator 101c establishes a communication connection to the image processing apparatus 200. The display 102 displays an operation screen for operating the image processing apparatus 200. For example, the controller 105, by executing the operation application, controls the communicator 101 to establish a connection to the image processing apparatus 200 and controls the display 102 to display the operation screen. The operation inputter 103 receives an operation on the operation screen for printing a file selected by the user from among the files stored in the storage 106.

When a file the same as the selected file is not saved at the image processing apparatus 200 side, the controller 105 controls the communicator 101 to transmit print data to the image processing apparatus 200, the print data being acquired by converting the file into a data format suitable for printing. The print data generated in this manner is also referred to as a print job. The data format suitable for printing is not particularly limited, but may be a printer command language (PCL), for example.

On the other hand, when the same file as the file selected by the user is saved at the image processing apparatus 200 side, the controller 105 controls the communicator 101 to transmit a print instruction for instructing to print the file, instead of transmitting the print data (print job), to the image processing apparatus 200. Such a print instruction requires a very small amount of data as compared with the print data.

In the present embodiment, when the controller 105 receives a print operation for a first file saved in the storage 106 from the user while the terminal apparatus 100 is mounted on the mount mechanism of the image processing apparatus 200 (i.e., while the terminal apparatus 100 is mechanically connected to the image processing apparatus 200), the controller 203 performs the following control. To be more specific, when a second file the same as the first file is not saved at the image processing apparatus 200 side, the controller 105 causes the image processing apparatus 200 to perform printing by the communicator 101 (e.g., USB communicator 101c) transmitting print data to the image processing apparatus 200, the print data being acquired by converting the first file into a data format suitable for printing. On the other hand, when the second file the same as the first file is saved at the image processing apparatus 200 side, the controller 105 causes the image processing apparatus 200 to perform printing by the communicator 101 transmitting a print instruction for instructing to print the second file, instead of transmitting the print data, to the image processing apparatus 200.

Note that the controller 105 may detect that the terminal apparatus 100 is mounted onto the image processing apparatus 200 in response to the BT/NFC communicator 101b or the USB communicator 101c receiving a signal from the image processing apparatus 200. Alternatively, a sensor (e.g., a sensor provided to a connection terminal) may be separately provided for detecting that the terminal apparatus 100 is mounted onto the image processing apparatus 200 so that the controller 105 may use the sensor to detect that the terminal apparatus 100 is mounted onto the image processing apparatus 200.

In the present embodiment, the controller 105 controls the communicator 101 to transmit identification information indicating the file selected by the user to the image processing apparatus 200 in response to the operation inputter 103 receiving an operation for printing the selected file. The identification information has to be information at least for specifying a file, and includes, for example, a file name. The identification information may include attribute information of the file, for example, a file format or a property of the file. The communicator 101 receives, from the image processing apparatus 200, a notification indicating whether a file the same as the selected file is saved at the image processing apparatus 200 side. The controller 105 determines whether the same file as the selected file is saved at the image processing apparatus 200 side based on the notification. This makes it possible to appropriately determine whether the same file as the selected file is saved at the image processing apparatus 200 side.

In the present embodiment, the operation inputter 103 receives a user operation on the operation screen for synchronizing one or more files stored in the storage 106 with the image processing apparatus 200. The controller 105 performs processing of synchronization by the communicator 101 transmitting the one or more files and a save request therefor to the image processing apparatus 200. Thus, since the files stored in the storage 106 can be synchronized, the files stored in the storage 106 can be easily saved at the image processing apparatus 200 side in advance. Note that when the processing of synchronization is performed, a large number of files may be needed to be transmitted to the image processing apparatus 200. Therefore, the processing of synchronization is preferably performed while the wireless LAN communicator 101a or the USB communicator 101c is connected to the image processing apparatus 200.

In the present embodiment, the save request includes a user identifier for identifying a user, and is a request to save the one or more files in a folder individually created for each user at the image processing apparatus 200 side. This allows the user to save the file of the user in a folder dedicated to the user provided at the image processing apparatus 200. Since the folder dedicated to the user cannot be referred to by other users, security can be improved and privacy can be protected.

The communicator 101 may include the wireless LAN communicator 101a that is the first communicator to perform wireless LAN communication and the BT/NFC communicator 101b that is an example of the second communicator to perform predetermined wireless communication in a narrower band than the wireless LAN communication. The controller 105 may control the wireless LAN communicator 101a to transmit the print data to the image processing apparatus 200 and control the BT/NFC communicator 101b to transmit the print instruction to the image processing apparatus 200. Thus, an appropriate communication scheme can be used in accordance with the content to be transmitted. For example, even when the wireless LAN communicator 101a is unavailable, the print instruction can be transmitted to the image processing apparatus 200 by the BT/NFC communicator 101b. Note that the print data may be transmitted by the USB communicator 101c. When the wireless LAN communicator 101a or the USB communicator 101c is available, the print instruction may be transmitted to the image processing apparatus 200 by the wireless LAN communicator 101a or the USB communicator 101c.

### (Configuration Example of Image Processing Apparatus)

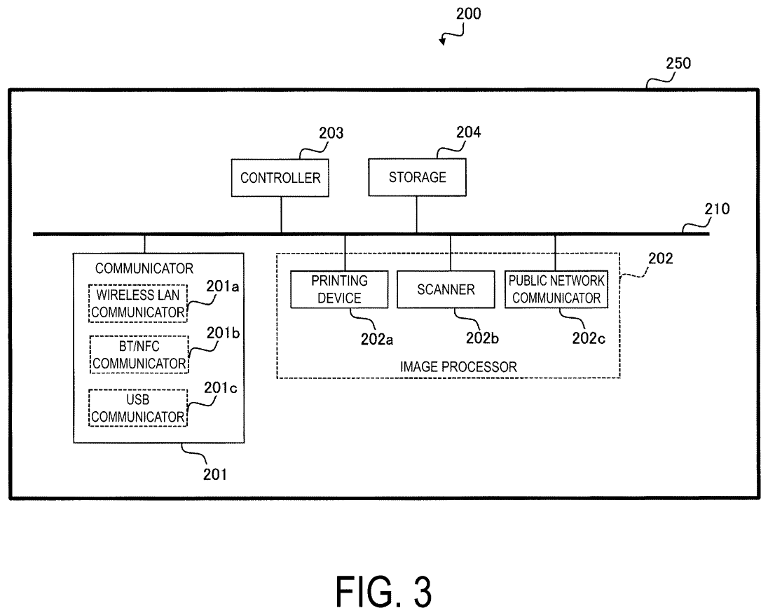

FIG. 3 is a diagram illustrating a configuration example of the image processing apparatus 200 according to the present embodiment.

The image processing apparatus 200 includes a communicator 201, an image processor 202, a controller 203, and a storage 204. The communicator 201, the image processor 202, the controller 203, and the storage 204 are electrically connected to each other through a bus 210, for example. An interface may be interposed between the bus 210 and each component. The communicator 201, the image processor 202, the controller 203, and the storage 204 are accommodated in a housing 250 of the image processing apparatus 200.

The communicator 201 communicates with the terminal apparatus 100. The communicator 201 includes at least one selected from the group consisting of a wireless LAN communicator 201a (first communicator), a BT/NFC communicator 201b (second communicator), and a USB communicator 201c. The wireless LAN communicator 201a performs wireless communication of the wireless LAN communication scheme with the terminal apparatus 100. The BT/NFC communicator 201b performs wireless communication of the BT scheme and/or NFC scheme with the terminal apparatus 100. The USB communicator 201c performs wireless communication of the USB scheme with the terminal apparatus 100.

The image processor 202 performs image processing including printing. For example, the image processor 202 includes a printing device 202a, a scanner 202b, and a public network communicator 202c. For example, the types of image processing include “print”, “copy”, “scan”, and “FAX (facsimile)”. Here, the type “copy” refers to a function in which the printing device 202a prints image data on a paper sheet, the image data being acquired by the scanner 202b scanning a document. The type “print” refers to a function in which the printing device 202a prints an image, the image being based on data received by the communicator 201 from the terminal apparatus 100 or based on data stored in a recording medium (not illustrated) connected to the image processing apparatus 200. The type “scan” refers to a function of storing image data acquired by the scanner 202b scanning a document. A save destination may be, for example, an auxiliary storage device (a nonvolatile memory from another viewpoint) included in the storage 204 or a storage medium connected to the image processing apparatus 200. The type “FAX” refers to a function in which the printing device 202a prints image data on a paper sheet, the image data being received by the public network communicator 202c from outside via a telephone line, and a function in which the public network communicator 202c externally transmits image data via the telephone line, the image data being acquired by the scanner 202b scanning a document. Note that the “image” may include only characters. A format of the “image data” may be various, and may be, for example, a vector format or a raster format. In the description of the present embodiment, “image” and “image data” may not be strictly distinguished from each other for the sake of convenience. The “image data” may be converted into an appropriate format in the course of the image processing. For example, the image data stored in the image processing apparatus 200 may be different in format from image data when the image processing (e.g., printing or FAX) is performed.

The printing device 202a performs printing under control of the controller 203. For example, the printing device 202a performs printing on a sheet set in a sheet feed tray, and discharges a printed sheet to a sheet discharge tray. The printing device 202a may include only one sheet feed tray or may include a plurality of sheet feed trays. From another viewpoint, the printing device 202a may have a function of selecting a size of a paper sheet. The printing device 202a may be configured to be capable of color (and monochrome and gray scale) printing, may be configured to be capable of only grayscale (and monochrome) printing, or may be configured to be capable of only monochrome printing. For example, the printing device 202a may be an inkjet printer that performs printing by ejecting ink, a thermal printer that performs printing by heating a heat-sensitive paper or an ink ribbon, or an electrophotographic printer (e.g., a laser printer) that transfers toner adhered to a photoreceptor irradiated with light. For example, the printing device 202a may be a line printer in which its head has a length across a width of the paper sheet (in a direction intersecting a conveyance direction of the paper sheet), or may be a serial printer in which its head moves in a width direction of the paper sheet.

The scanner 202b performs scanning under control of the controller 203. The scanner 202b images (scans) a document set on a document table or an auto document feeder (ADF) by an imaging device that moves along a document glass to generate image data.

The public network communicator 202c performs image data communication via a public network under control of the controller 203. The public network includes a telephone network and/or the Internet. The public network communicator 202c may communicate with a file server, an e-mail server, and/or a web server. The communication may be a wired communication or may include a wireless communication.

The controller 203 includes one or more processors, and controls the entire image processing apparatus 200. For example, the controller 203 executes programs stored in the storage 204 to perform various types of processing. In the present embodiment, the controller 203 controls the communicator 201, the image processor 202, and the storage 204. Note that the controller 203 may include a logic circuit configured to perform only a certain operation. The operations of the image processing apparatus 200 described above and below may also be operations controlled by the controller 203.

For example, the storage 204 includes various memories such as a ROM, a RAM, and an auxiliary storage device. Note that a combination of the controller 203 and the storage 204 may be considered as a computer. The program to be executed by the controller 203 is stored in the ROM and/or the auxiliary storage device of the storage 204, for example. The storage 204 may include a removable storage medium such as a memory card. The storage 204 may include a local storage (e.g., NAS) provided on the LAN.

Note that FIG. 3 is merely a schematic view. For example, a number of the controllers 203 and the storages 204 may be provided in a distributed manner. For example, a processor included in each component (a controller that controls each component from another viewpoint) and a higher layer processor (a higher layer controller that controls the controller of each component) may be provided. In such a case, the controller 203 may be considered as the higher layer controller, or may be considered as a combination of the controller of each component and the higher layer controller.

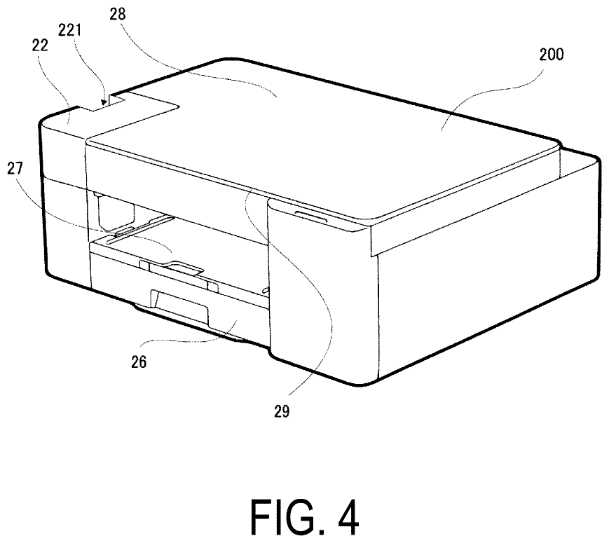

FIG. 4 is a diagram illustrating an outer appearance configuration example of the image processing apparatus 200 according to the embodiment.

In the example of FIG. 4, the image processing apparatus 200 includes a sheet feed tray 26, a sheet discharge tray 27, a document table cover 28, and a document table 29. Sheets being set in the sheet feed tray 26 are conveyed to the printing device 202a (see FIG. 3) one by one, printing is performed in the printing device 202a, and the sheets are discharged from the sheet discharge tray 27. The document table cover 28 is capable of opening upward with an end portion of the document table 29 being a fulcrum, allows a sheet to be placed on the document table 29 while the document table cover 28 is open, and allows scanning to be performed while the document table cover 28 is open or the document table cover 28 is closed. An operation panel 22 is provided at a corner of the image processing apparatus 200 on an upper surface thereof. The operation panel 22 is provided with a mount mechanism 221 that mounts the terminal apparatus 100 on the housing 250 of the image processing apparatus 200. When the terminal apparatus 100 is mounted on the mount mechanism 221, the terminal apparatus 100 is mechanically connected to the image processing apparatus 200. For example, the terminal apparatus 100 may be leaned against the mount mechanism 221 so that the terminal apparatus 100 receives various operations related to the image processing apparatus 200 from the user.

The mount mechanism 221 may be provided at an edge portion of the operation panel 22. For example, the mount mechanism 221 is formed by cutting out a part of the edge portion of the operation panel 22. The mount mechanism 221 may be provided as a place against which the terminal apparatus 100 is leaned. When the terminal apparatus 100 is leaned against the mount mechanism 221 and the terminal apparatus 100 is connected to the image processing apparatus 200 via a wired medium or a wireless medium, the terminal apparatus 100 can be caused to display an execution screen of the operation application. Thus, even if the image processing apparatus 200 does not have a configuration of displaying an operation screen, the terminal apparatus 100 can be used as the operation screen for the image processing apparatus 200.

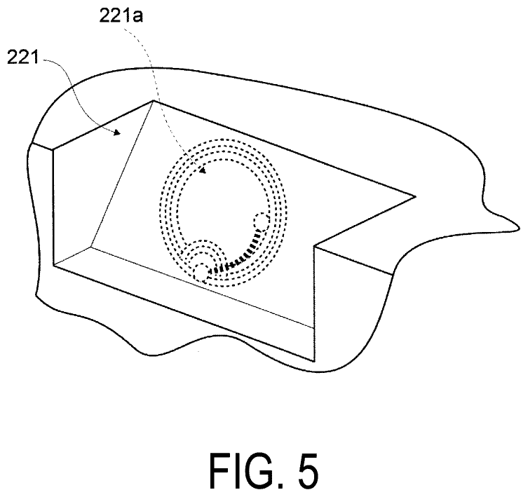

FIG. 5 is a diagram illustrating an example of the mount mechanism 221 via which the terminal apparatus 100 (see FIG. 1) is leaned against the image processing apparatus 200 (see FIG. 1) according to the present embodiment.

In the example of FIG. 5, an NFC antenna 221a is embedded in the mount mechanism 221. Thus, when the terminal apparatus 100 equipped with the function of NFC is leaned against the mount mechanism 221, the terminal apparatus 100 can perform communication with the image processing apparatus 200 via the NFC antenna 221a. This thus enables communication between the terminal apparatus 100 and the image processing apparatus 200 via the NFC antenna 221a, and accordingly the terminal apparatus 100 can be caused to display the execution screen of a printer operation application. Using the communication via the NFC antenna 221a, information (an SSID or the like) necessary for establishing wireless LAN communication connection may be transmitted and received between the terminal apparatus 100 and the image processing apparatus 200. Then, the terminal apparatus 100 and the image processing apparatus 200 may establish wireless LAN communication connection, and the terminal apparatus 100 may be allowed to display the execution screen of the printer operation application through the wireless LAN communication. A Bluetooth (trade name) antenna may be embedded in the mount mechanism 221. In this case, when the terminal apparatus 100 equipped with a Bluetooth antenna is leaned against the mount mechanism 221 and after pairing is performed, various signals may be transmitted and received between the terminal apparatus 100 and the image processing apparatus 200. By doing so, the terminal apparatus 100 may be allowed to display the execution screen of the printer operation application through the Bluetooth communication.

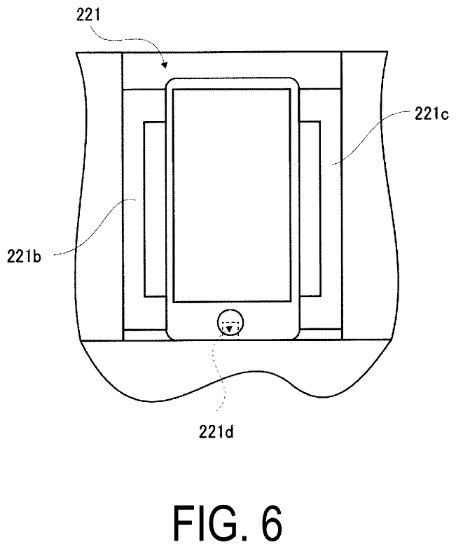

FIG. 6 is a diagram illustrating an example of the mount mechanism 221 via which the terminal apparatus 100 (see FIG. 1) is held vertically against the image processing apparatus 200 (see FIG. 1) according to the present embodiment.

In an example of FIG. 6, the terminal apparatus 100 is held by holding parts 221b and 221c while the terminal apparatus 100 is held vertically against the mount mechanism 221 and a connection terminal 221d is inserted into a bottom portion of the terminal apparatus 100 to allow electrical connection. Specifically, from the left side of the mount mechanism 221, the holding part 221b holds an upper side and a lower side of the terminal apparatus 100 at a left edge, and avoids pressing on a volume adjustment button, for example. From the right side of the mount mechanism 221, the holding part 221c holds an upper side and a lower side of the terminal apparatus 100 at a right edge, and avoids pressing on a power button, for example. Note that the holding parts 221b and 221c may rotate by 90 degrees, and the terminal apparatus 100 may be held with the terminal apparatus 100 being positioned horizontally. In this case, the connection terminal 221d itself may rotate by 90 degrees as well, and a cord of the connection terminal 221d on a terminal side may be extended.

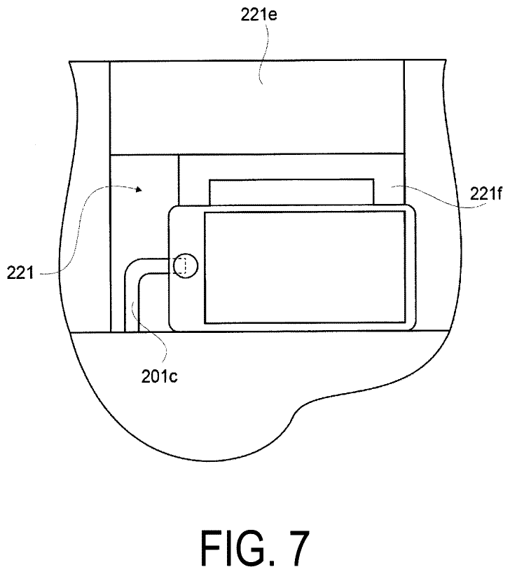

FIG. 7 is a diagram illustrating an example of the mount mechanism 221 via which the terminal apparatus 100 (see FIG. 1) is held horizontally against the image processing apparatus 200 (see FIG. 1) according to the present embodiment.

In an example of FIG. 7, the terminal apparatus 100 is held by holding parts 221e and 221f while the terminal apparatus 100 is held horizontally against the mount mechanism 221 and the connection terminal 221d is inserted into the bottom portion of the terminal apparatus 100 to allow electrical connection. Specifically, the holding part 221f holds the upper side and the lower side of the terminal apparatus 100 at the left edge. The holding part 221e holds a back side of the holding part 221f.

As described above, when the terminal apparatus 100 is mounted on the mount mechanism 221, wireless communication connection can be established via the NFC antenna 221a or communication connection can be established by mechanical connection via the connection terminal 221d. Note that although the example is illustrated in which the mount mechanism 221 is provided at the edge portion of the operation panel 22, the present invention is not limited thereto. The mount mechanism 221 has to be provided at least to the housing 250 of the image processing apparatus 200, and may be provided, for example, on a top plate, a side plate, or a front surface of the housing 250. Although an example is illustrated in which a part of the operation panel 22 is cut out as the mount mechanism 221, the mount mechanism is not limited thereto. As the mount mechanism 221, a recessed portion may be provided in the housing 250 so that the terminal apparatus 100 may be mounted in the recessed portion, or a pedestal on which the terminal apparatus 100 is leaned may be provided in the housing 250.

Note that the controller 203 may detect that the terminal apparatus 100 is mounted on the mount mechanism 221 in response to the BT/NFC communicator 201b or the USB communicator 201c receiving a signal from the terminal apparatus 100. Alternatively, a sensor (e.g., a sensor provided to the connection terminal) may be separately provided for detecting that the terminal apparatus 100 is mounted on the mount mechanism 221 so that the controller 203 may use the sensor to detect that the terminal apparatus 100 is mounted on the mount mechanism 221.

In the image processing apparatus 200 configured as described above, the communicator 201 is communicably connected to the terminal apparatus 100. The image processor 202 performs image processing including printing. The controller 203 controls the image processor 202 based on the communication of the communicator 201. When a file is not saved, in the storage 204, that is the same as the file selected by the user of the terminal apparatus 100 from among the files saved at the terminal apparatus 100 side, the communicator 201 receives print data from the terminal apparatus 100, the print data being acquired by converting the file into a data format suitable for printing. On the other hand, when the same file as the selected file is saved in the storage 204, the communicator 201 receives a print instruction for instructing to print the file, instead of receiving the print data, from the terminal apparatus 100. When the communicator 201 receives the print data, the controller 203 controls the image processor 202 to perform printing using the print data (that is, to execute a print job). When the communicator 201 receives the print instruction, the controller 203 acquires the same file as the selected file from the storage 204, converts the acquired file into print data (print job), and controls the image processor 202 to perform the printing by using the print data.

In the present embodiment, when the controller 203 receives a print operation for the first file saved in the terminal apparatus 100 from the user while the terminal apparatus 100 is mounted on the mount mechanism 221, the controller 203 performs the following control. To be more specific, when the second file the same as the first file is not saved in the storage 204, the controller 203 causes the image processor 202 (the printing device 202a) to perform printing by the communicator 201 (e.g., the BT/NFC communicator 201b or the USB communicator 201c) receiving print data from the terminal apparatus 100, the print data being acquired by converting the first file into a data format suitable for printing. On the other hand, when the second file the same as the first file is saved in the storage 204, the controller 203 causes the image processor 202 (the printing device 202a) to perform printing by the communicator 201 (e.g., the BT/NFC communicator 201b or the USB communicator 201c) receiving a print instruction for instructing to print the second file, instead of receiving the print data, from the terminal apparatus 100.

That is, when the controller 203 receives a print operation for a target file from the user of the terminal apparatus 100 while the terminal apparatus 100 is mounted on the housing 250, the controller 203 performs the following control. Specifically, when the controller 203 receives the print operation for the target file from the user of the terminal apparatus 100 while the terminal apparatus 100 is mounted on the housing 250 of the image processing apparatus 200, the controller 203 performs the following control. To be more specific, when the target file is saved in the terminal apparatus 100, the controller 203 causes the image processor 202 to perform printing by the communicator 201 receiving print data from the terminal apparatus 100, the print data being acquired by converting the target file into a data format suitable for printing. On the other hand, when the target file is saved in the storage 204, the controller 203 causes the image processor 202 to perform printing by receiving a print instruction for instructing to print the target file, instead of receiving the print data, from the terminal apparatus 100.

The communicator 201 also receives identification information indicating the selected file from the terminal apparatus 100. The controller 203 generates a notification indicating whether the same file as the selected file is saved in the storage 204 based on the identification information, and controls the communicator 201 to transmit the notification to the terminal apparatus 100. Note that when the same file as the selected file is saved in the storage 204, the controller 203 may immediately start the print processing using the file. In this case, the identification information indicating the selected file may be regarded as the print instruction for instructing to print the file.

In the present embodiment, the communicator 201 receives a save request for one or more files from the terminal apparatus 100. The controller 203 performs processing of synchronization by saving, in the storage 204, a file that is not saved in the storage 204 from among the one or more files, based on the save request. That is, the controller 203 does not save all the files received from the terminal apparatus 100 in the storage 204, but saves only the file corresponding to a difference in the storage 204. This allows a storage capacity of the storage 204 to be saved.

The controller 203 may start the processing of synchronization when the terminal apparatus 100 is mounted on the mount mechanism 221. That is, when the terminal apparatus 100 is mechanically connected to the image processing apparatus 200, the controller 203 may automatically start the processing of synchronization without a user operation indicating the start of the processing of synchronization. By doing so, when the terminal apparatus 100 is mechanically connected to the image processing apparatus 200, a file that has been saved in the terminal apparatus 100 but has not yet been saved in the image processing apparatus 200 can be saved in the image processing apparatus 200, and the file can be automatically synchronized between the terminal apparatus 100 and the image processing apparatus 200. The controller 203 may stop the processing of synchronization when the terminal apparatus 100 is removed from the mount mechanism 221. That is, when the mechanical connection between the terminal apparatus 100 and the image processing apparatus 200 is released, the controller 203 may automatically stop the processing of synchronization without a user operation indicating the stop of the processing of synchronization. Here, the controller 203 may cause the communicator 201 to maintain the wireless communication with the terminal apparatus 100 even when stopping the processing of synchronization.

Alternatively, when the terminal apparatus 100 is mounted on the mount mechanism 221, the controller 203 may cause the terminal apparatus 100 to display an inquiry whether to perform the processing of synchronization via the communicator 201. In this case, the controller 203 starts the processing of synchronization based on the terminal apparatus 100 receiving a user operation indicating the start of the processing of synchronization.

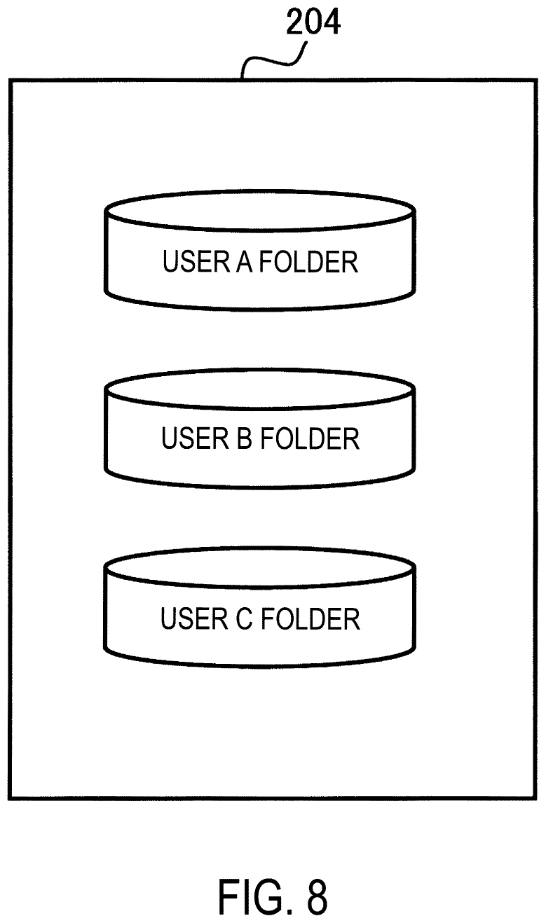

In the present embodiment, the controller 203 may manage a folder individually created for each user as illustrated in FIG. 8. The save request from the terminal apparatus 100 may include a user identifier for identifying the user. The controller 203 saves the file in the storage 204 in association with the folder of the user indicated by the user identifier. This allows each file to be saved in a separate folder for each corresponding user. The controller 203, even when receiving a reference request for a folder of a certain user from another user, rejects the reference request or does not disclose the inside of the folder.

As described above, the communicator 201 may include the wireless LAN communicator 201a that corresponds to the first communicator to perform wireless LAN communication and the BT/NFC communicator 201b that is an example of the second communicator to perform predetermined wireless communication in a narrower band than the wireless LAN communication. The wireless LAN communicator 201a receives the print data from the terminal apparatus 100. The BT/NFC communicator 201b receives the print instruction from the terminal apparatus 100. Note that the print data may be received by the USB communicator 201c from the terminal apparatus 100. When the wireless LAN communicator 201a or the USB communicator 201c is available, the print instruction may be received from the terminal apparatus 100 by the wireless LAN communicator 201a or the USB communicator 201c.

### System Operation Example

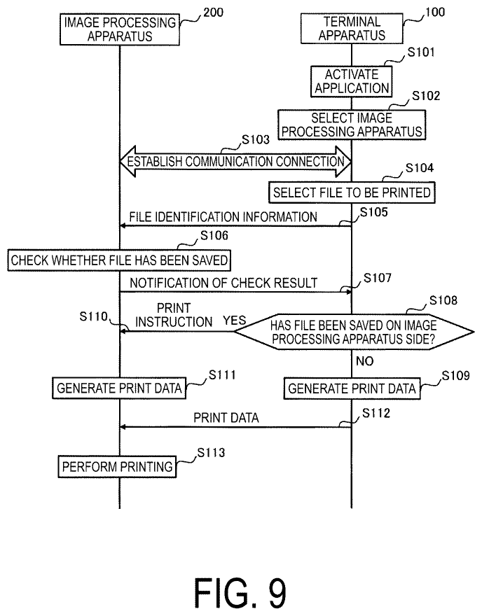

An operation example of the printing system 1 is described according to the present embodiment. FIG. 9 is a diagram illustrating an operation example of the printing system 1 according to the present embodiment.

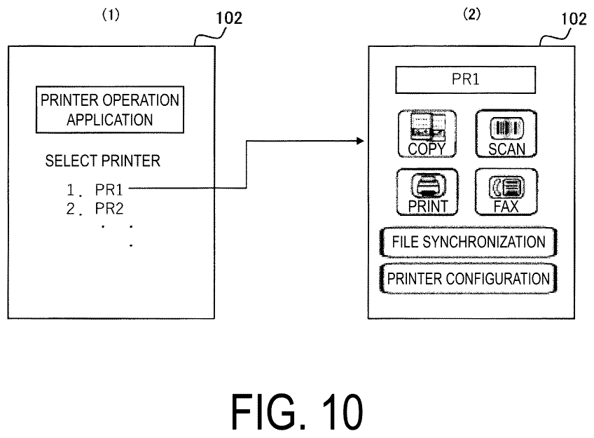

In step S101, the terminal apparatus 100 activates an operation application used to operate the image processing apparatus 200 in response to a user operation. Alternatively, the terminal apparatus 100 may automatically start the operation application in response to the terminal apparatus 100 being mounted on the mount mechanism 221 of the image processing apparatus 200 without a user operation. Here, the terminal apparatus 100 causes the display 102 to display an operation screen (a printer selection screen in the illustrated example) as illustrated in (1) of FIG. 10.

In step S102, the terminal apparatus 100 receives, from the user, an operation to select the image processing apparatus 200 to be connected. For example, the terminal apparatus 100 receives, from the user, an operation to select a printer “PR1” illustrated in (1) of FIG. 10. Alternatively, when the terminal apparatus 100 is mounted on the mount mechanism 221 of the image processing apparatus 200, the terminal apparatus 100 may receive type (model) information from the image processing apparatus 200 to automatically select the image processing apparatus 200 to be connected.

In step S103, the terminal apparatus 100 establishes communication connection to the selected image processing apparatus 200. Here, the terminal apparatus 100 causes the display 102 to display the operation screen as a menu screen as illustrated in (2) of FIG. 10. The terminal apparatus 100 may acquire information indicating the type (model) of the connected image processing apparatus 200 from the image processing apparatus 200 and cause the display 102 to display the menu screen optimized according to the type. For example, the terminal apparatus 100 may hold information that associates the type with the menu screen to cause the display 102 to display an optimum menu screen using the information. Alternatively, the terminal apparatus 100 may acquire data of the menu screen from the connected image processing apparatus 200 to cause the display 102 to display an optimum menu screen using the data. The menu screen includes buttons for respective types of image processing. In the illustrated example, the menu screen includes a “copy” button, a “scan” button, a “print” button, and a “FAX” button. In the present embodiment, the menu screen further includes a “file” synchronization button. In the terminal apparatus 100, when the “file” synchronization button is selected (operated) by the user, the operation screen transitions to a selection screen for selecting a file to be synchronized. In the following description, assume that the “print” button is selected (operated) by the user and an operation for printing a file in the terminal apparatus 100 is received.

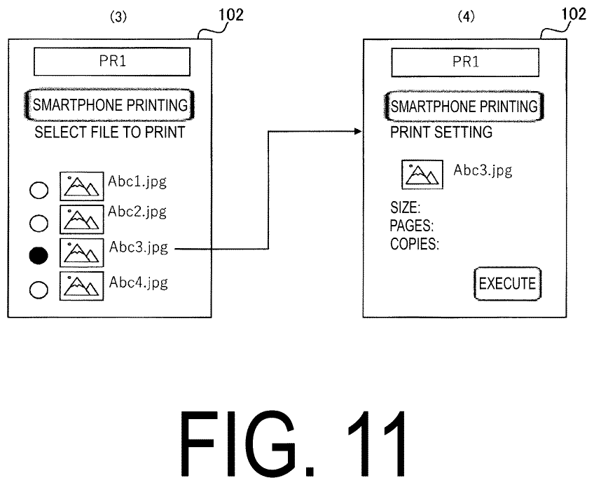

In step S104, the terminal apparatus receives, from the user, an operation to select a file to be printed from among the files saved in the terminal apparatus 100. Here, the terminal apparatus 100 causes the display 102 to display the operation screen as a file selection screen as illustrated in (3) of FIG. 11. In the illustrated example, assume that a file is selected which is an image file and has a file name of “Abc3.jpg”. Then, the terminal apparatus 100 causes the display 102 to display the operation screen as a print setting screen as illustrated in (4) of FIG. 11. In the print setting screen, a size, a sheet, and the number of sheets can be selected, for example. When an “execute” button on the print setting screen is operated, the process proceeds to the next step.

In step S105, the terminal apparatus 100 transmits the identification information of the file selected in step S104 to the image processing apparatus 200. Note that before the “execute” button is operated, the terminal apparatus 100 may transmit the identification information of the file to the image processing apparatus 200 when the file to be printed is selected on the file selection screen.

In step S106, the image processing apparatus 200 compares the identification information received from the terminal apparatus 100 with each file saved in the storage 204 of the image processing apparatus 200 to check whether the file to be printed has been saved in the storage 204.

In step S107, the image processing apparatus 200 generates a notification indicating a check result of step S106 and transmits the notification to the terminal apparatus 100.

In step S108, based on the notification, the terminal apparatus 100 determines whether the file to be printed has been saved at the image processing apparatus 200 side.

When the terminal apparatus 100 determines that the file to be printed has not been saved at the image processing apparatus 200 side (step S108: NO), the terminal apparatus 100, in step S109, generates print data from the file to be printed that is saved in the terminal apparatus 100. In step S112, the generated print data is transmitted to the image processing apparatus 200. In this case, in step S113, the image processing apparatus 200 executes printing using the print data from the terminal apparatus 100.

On the other hand, when the terminal apparatus 100 determines that the file to be printed has been saved at the image processing apparatus 200 side (step S108: YES), the terminal apparatus 100, in step S110, transmits a print instruction to the image processing apparatus 200. The print instruction may include identification information of the file to be printed. In this case, in step S111, the image processing apparatus 200 generates print data from the file to be printed that is saved in the image processing apparatus 200. Then, in step S113, the image processing apparatus 200 performs printing using the print data generated by the image processing apparatus 200.

As described above, according to the present embodiment, when a file to be printed is saved at the image processing apparatus side, the terminal apparatus 100 transmits the print instruction for instructing to print the file, instead of transmitting the print data, to the image processing apparatus. This makes it possible to shorten the time until the printing is completed compared to the transmitting of the print data, and improve convenience for the user.

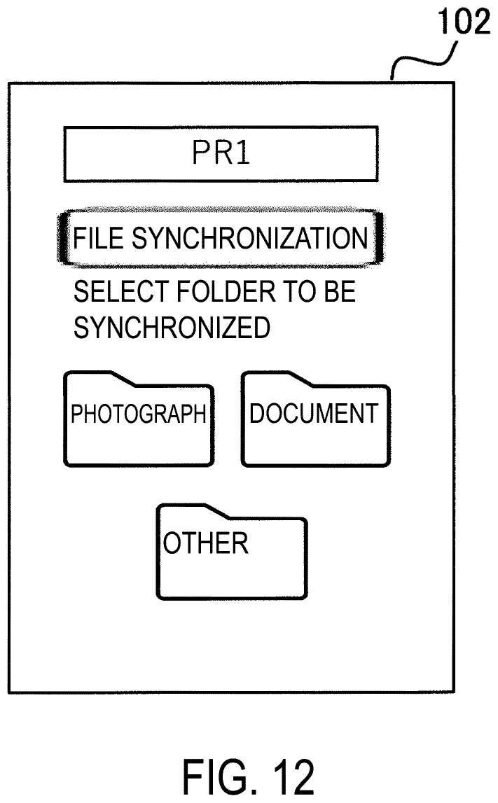

FIG. 12 is a diagram illustrating an example of the selection screen displayed on the terminal apparatus 100 for selecting a file to be synchronized. In the illustrated example, a plurality of files can be collectively selected as synchronization targets in folder units, such as a “photo” folder, a “text” folder, and an “other” folder. The terminal apparatus 100 specifies each of files belonging to the folder selected by the user as a file to be synchronized.

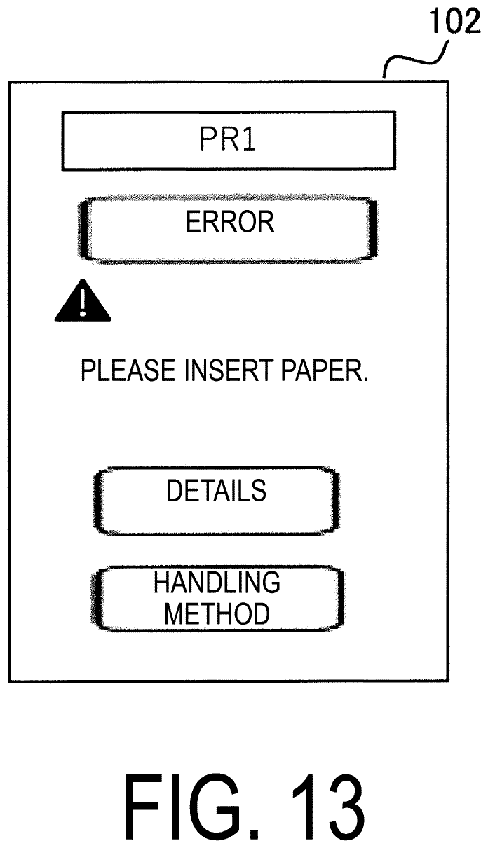

FIG. 13 illustrates an example of an error screen that is an operation screen displayed on the terminal apparatus 100 when an error occurs at the image processing apparatus 200 side. The illustrated example illustrates the error screen when there is no sheet. The error screen includes a “details” button for displaying details of the error and a “handling method” button for displaying a handling method for the error.

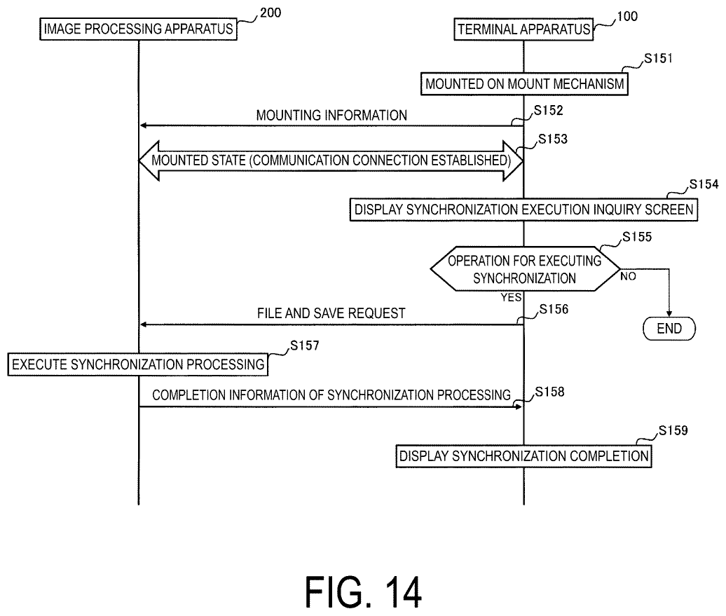

FIG. 14 is a diagram illustrating an example of the processing of synchronization between the image processing apparatus 200 and the terminal apparatus 100. Here, an operation example is described in which the processing of synchronization is performed when the terminal apparatus 100 is mounted on the mount mechanism 221 of the image processing apparatus 200.

In step S151, the terminal apparatus 100 is mounted on the mount mechanism 221. When the terminal apparatus 100 is mounted on the mount mechanism 221, the terminal apparatus 100 being mounted is detected by, for example, a sensor provided to the connection terminal.

In step S152, the terminal apparatus 100 transmits mounting information of the terminal apparatus 100 to the image processing apparatus 200. The mounting information of the terminal apparatus 100 may include identification information of the terminal apparatus 100 and/or identification information of the user, or may include communication-related information for establishing communication connection. The image processing apparatus 200 receives the mounting information of the terminal apparatus 100. As a result, the image processing apparatus 200 establishes communication connection based on the terminal apparatus 100 being mounted (step S153).

In step S154, when the terminal apparatus 100 establishes the communication connection to the image processing apparatus 200 based on the terminal apparatus being mounted to the image processing apparatus 200, the terminal apparatus 100 causes the display 102 display a synchronization execution inquiry screen based on the communication with the image processing apparatus 200, and receives a user operation for the synchronizing on the operation screen (inquiry screen).

The terminal apparatus 100, when receiving the user operation for the synchronizing on the operation screen (step S155: YES), in step S156, determines that there is an instruction to execute synchronization, and transmits a signal of a file and a save request to the image processing apparatus 200. On the other hand, the terminal apparatus 100 when receiving the user operation for not performing the synchronizing on the operation screen (step S155: NO), determines that there is no instruction to execute synchronization, and does not execute the processing of synchronization.

In step S157, when the image processing apparatus 200 receives the signal of the file and the save request from the terminal apparatus 100, the image processing apparatus 200 executes the processing of synchronization. As described above, the terminal apparatus 100 causes the display 102 to display the inquiry about the processing of synchronization when establishing the communication connection to the image processing apparatus 200 based on the terminal apparatus 100 being mounted to the image processing apparatus 200. This makes it difficult to forget to synchronize the file saved in the terminal apparatus 100 with the image processing apparatus 200.

In step S158, after executing the processing of synchronization, the image processing apparatus 200 transmits completion information of the processing of synchronization to the terminal apparatus 100.

In step S159, the terminal apparatus 100, when receiving the completion information of the processing of synchronization, causes the display 102 to display a screen indicating that the processing of synchronization with the image processing apparatus 200 is completed. This allows the user to easily recognize the completion of the processing of synchronization with the image processing apparatus 200.

Note that although the example is illustrated in which the synchronization execution inquiry screen is displayed on the display 102 of the terminal apparatus 100, an operation screen may be displayed on which a file to be synchronized is displayed and the file can be selected.

In the example illustrated in FIG. 14, the inquiry whether to perform the processing of synchronization is displayed on the display of the terminal apparatus 100 after the terminal apparatus 100 is mounted on the mount mechanism 221 and the mounting of the terminal apparatus 100 to the image processing apparatus 200 is established, the present invention is not limited thereto. When the terminal apparatus 100 is mounted to the image processing apparatus 200, the terminal apparatus 100 may transmit the file and the save request to the image processing apparatus 200 to perform the processing of synchronization without displaying the synchronization execution inquiry screen on the display 102. That is, the image processing apparatus 200 may start the processing of synchronization when the terminal apparatus 100 is mounted on the mount mechanism 221. This makes it difficult to forget to synchronize the file saved in the terminal apparatus 100 with the image processing apparatus 200.

Note that when the mounting of the terminal apparatus 100 to the image processing apparatus 200 is released while the file of the terminal apparatus 100 is being synchronized with the image processing apparatus 200, the processing of synchronization may be stopped. Even when the mounting of the terminal apparatus 100 to the image processing apparatus 200 is released, the communication connection (wireless connection) between the image processing apparatus 200 and the terminal apparatus 100 may be maintained.

### First Variation

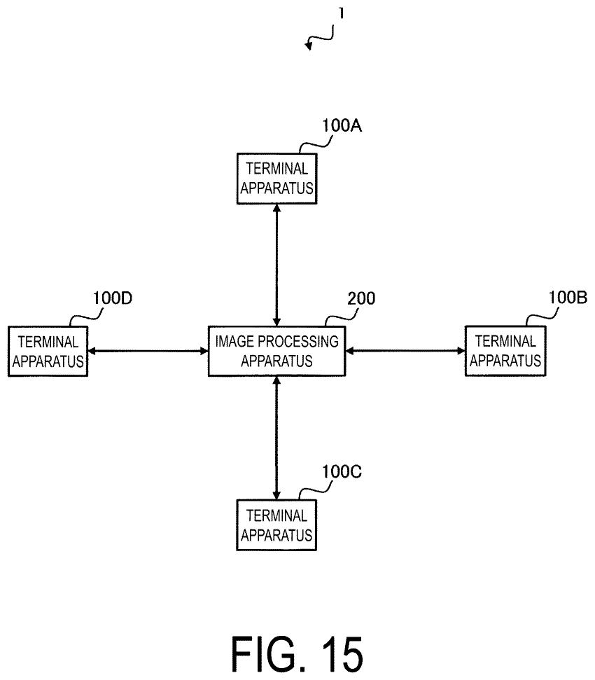

FIG. 15 is a diagram for illustrating a first variation of the operation according to the embodiment described above.

In the present variation, the image processing apparatus 200 is communicably connected to a plurality of terminal apparatuses 100 (terminal apparatuses 100A to 100D in the illustrated example). Each of the plurality of terminal apparatuses 100 may be connected to the image processing apparatus 200 via direct wireless communication such as a wireless LAN, or may be mechanically and electrically connected to the image processing apparatus 200 via wired communication such as the USB scheme. One of the plurality of terminal apparatuses 100 may be mounted on the mount mechanism 221 of the image processing apparatus 200.

When the plurality of terminal apparatuses 100 are communicably connected to the image processing apparatus 200, each of the plurality of terminal apparatuses 100 can perform the processing of synchronization. As illustrated n FIG. 8, the image processing apparatus 200 has a folder individually created for each user stored in the storage 204. Each terminal apparatus 100 (each user) can transmit a file, a user identifier, and a save request to the image processing apparatus 200 in accordance with the processing of synchronization to save the file of the terminal apparatus 100 (each user) in a folder dedicated to the terminal apparatus 100 (each user).

Depending on a state of the image processing of one terminal apparatus 100 among the plurality of terminal apparatuses 100, the image processing apparatus 200 may stop the processing of synchronization of other terminal apparatuses 100. For example, when the terminal apparatuses 100A and 100B are communicably connected to the image processing apparatus 200 and the terminal apparatus 100A is performing processing of synchronization with the image processing apparatus 200, if the image processing apparatus 200 starts image processing such as printing by the terminal apparatus 100B, the processing of synchronization of the terminal apparatus 100A may be stopped. That is, when the image processor 202 starts image processing by one terminal apparatus 100 among the plurality of terminal apparatuses 100, the image processing apparatus 200 (the controller 203) may stop processing of synchronization with other terminal apparatuses 100 among the plurality of terminal apparatuses 100. This can suppress an increase in the load on the image processing apparatus 200.

In the image processing apparatus 200, the communicator 201 can simultaneously communicate with the plurality of terminal apparatuses 100. The controller 203 performs the processing of synchronization individually with each of the plurality of terminal apparatuses 100. Since the processing of synchronization imposes a heavy load on the image processing apparatus 200, the image processing apparatus 200 (the controller 203) performs the processing of synchronization individually with each of the plurality of terminal apparatuses 100, thereby preventing the processing of synchronization from being performed simultaneously with the plurality of terminal apparatuses 100 and suppressing an increase in the load on the image processing apparatus 200.

Here, in the image processing apparatus 200, the communicator 201 may include the USB communicator 201c (wired communicator) that performs wired communication with one terminal apparatus 100 mounted on the mount mechanism 221 among the plurality of terminal apparatuses 100, and the wireless LAN communicator 201a (wireless communicator) that performs wireless communication with other terminal apparatuses 100 of the plurality of terminal apparatuses 100. The controller 203 may perform the processing of synchronization with the one terminal apparatus 100 via the USB communicator 201c (wired communicator). That is, the image processing apparatus 200 (the controller 203) may perform the processing of synchronization only with the terminal apparatus 100 connected to the USB communicator 201c (wired communicator) among the plurality of terminal apparatuses 100. As a result, compared to wireless communication, wired communication enables high-speed and stable communication, and processing of synchronization can be executed smoothly and quickly.

### Second Variation

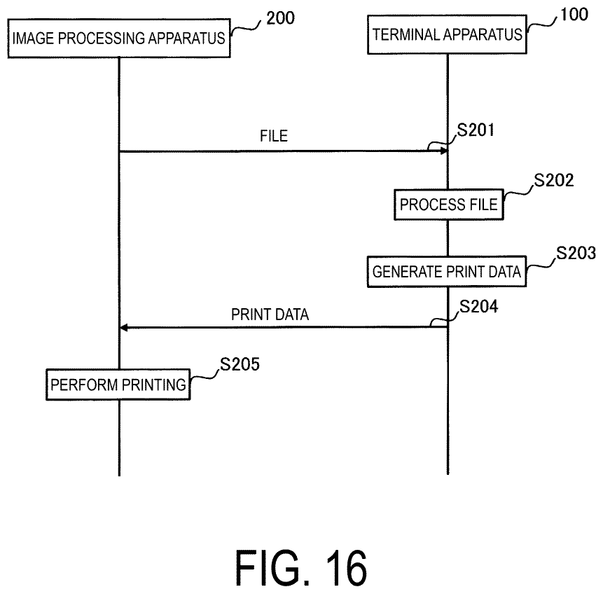

FIG. 16 is a diagram illustrating a second variation of the operation according to the embodiment described above.

In the present variation, in the terminal apparatus 100, the controller 105 acquires a file saved at the image processing apparatus 200 side using the communicator 101, and processes the acquired file to generate a processed file. Then, the controller 105 controls the communicator 101 to transmit print data to the image processing apparatus 200, the print data being acquired by converting the processed file into a data format suitable for printing.

On the other hand, in the image processing apparatus 200, the controller 203 controls the communicator 201 to transmit a file saved at the image processing apparatus 200 side to the terminal apparatus 100. The communicator 201 receives the print data acquired by processing a file and converting the file into a data format suitable for printing from the terminal apparatus 100.

As illustrated in FIG. 16, in step S201, the image processing apparatus 200 transmits a file to the terminal apparatus 100. For example, the image processing apparatus 200 transmits a file (scan file) generated by scanning to the terminal apparatus 100.

In step S202, the terminal apparatus 100 processes the file from the image processing apparatus 200 in response to a user operation. For example, the terminal apparatus 100 draws an object (a line or a figure) in the scan file to generate a processed file.

In step S203, the terminal apparatus 100 generates print data (print job) from the generated processed file.

In step S204, the terminal apparatus 100 transmits the generated print data to the image processing apparatus 200.

In step S205, the image processing apparatus 200 performs printing using the print data from the terminal apparatus 100.

### Third Variation

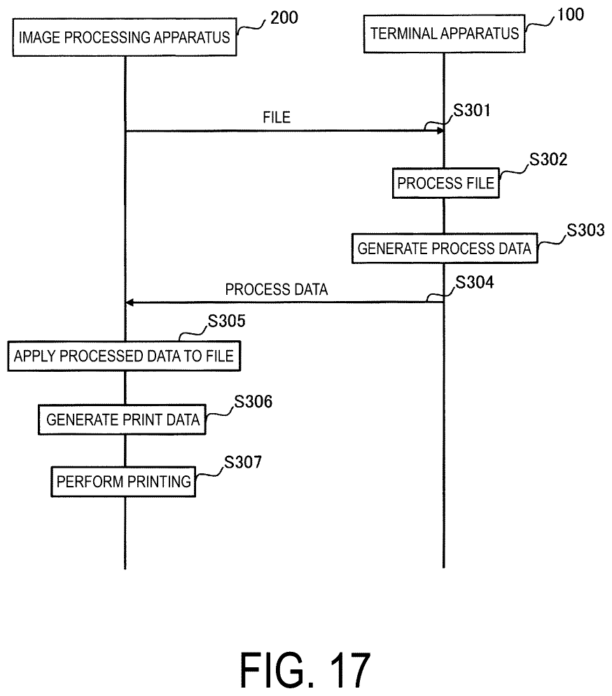

FIG. 17 is a diagram illustrating a third variation of the operation according to the embodiment described above.

In the present variation, in the terminal apparatus 100, the controller 105 acquires a file saved at the image processing apparatus 200 side using the communicator 101, processes the acquired file to generate process data representing content of a process, and controls the communicator 101 to transmit the process data to the image processing apparatus 200. That is, in the present variation, the terminal apparatus 100 does not transmit the print data to the image processing apparatus 200, but transmits the content of the process performed on the terminal apparatus 100 side to the image processing apparatus 200. For example, the terminal apparatus 100 transmits the process data as data of an object (a line or a figure) drawn in the scan file to the image processing apparatus 200. This makes it possible to significantly reduce the amount of data to be transmitted to the image processing apparatus 200 as compared with the first variation described above.

In the present variation, in the image processing apparatus 200, the controller 203 controls the communicator 201 to transmit a file saved at the image processing apparatus 200 side to the terminal apparatus 100. The communicator 201 receives, from the terminal apparatus 100, the process data representing the content of the process performed on the file on the terminal apparatus 100 side. The controller 203 controls the image processor 202 to apply the process data to the file to generate a processed file, convert the processed file into print data, and perform printing using the print data. That is, in the present variation, the print data (print job) is generated at the image processing apparatus 200 side.

As illustrated in FIG. 17, in step S301, the image processing apparatus 200 transmits a file to the terminal apparatus 100. For example, the image processing apparatus 200 transmits a file (scan file) generated by scanning to the terminal apparatus 100.

In step S302, the terminal apparatus 100 processes the file from the image processing apparatus 200 in response to a user operation. For example, the terminal apparatus 100 draws an object (a line or a figure) in the scan file to generate a processed file.

In step S303, the terminal apparatus 100 extracts (generates) process data as data of an object corresponding to a processed portion included in the processed file.

In step S304, the terminal apparatus 100 transmits the generated process data to the image processing apparatus 200.

In step S305, the image processing apparatus 200 applies the process file from the terminal apparatus 100 to the file (scan file). Specifically, the image processing apparatus 200 generates the processed file by superimposing an object indicated by the process data on the file.

In step S306, the image processing apparatus 200 generates print data (print job) from the processed file generated in step S305.

Then, in step S307, the image processing apparatus 200 performs printing using the print data generated in step S306.

### Other Embodiments

In the above described embodiments, “printing” may include 3D printing. That is, the image processing apparatus 200 may have a function of 3D printing. For example, the printing device 202a may be a 3D printer that forms a three-dimensional object using resins and/or metallic powders.

The operational flow of each of the embodiments described above need not necessarily be executed in chronological order according to the order described in the flow diagram. For example, the steps of operation may be performed in a different order from that described in the flow diagram or may be performed in parallel. Some steps of operation may be omitted and additional steps may be added to the process.

A program that causes the computer (the image processing apparatus 200, the terminal apparatus 100) to perform operations according to the embodiments described above may be provided. The program may be recorded in a computer readable medium. Use of the computer readable medium enables the program to be installed on a computer (an information processing apparatus). Here, the computer readable medium on which the program is recorded may be a non-transitory recording medium. The non-transitory recording medium is not particularly limited, and may be, for example, a recording medium such as a CD-ROM or a DVD-ROM.

The phrases “based on” and “depending on/in response to” used in the present disclosure do not mean “based only on” and “only depending on/in response to,” unless specifically stated otherwise. The phrase “based on” means both “based only on” and “based at least in part on”. The phrase “depending on” means both “only depending on” and “at least partially depending on”. The terms “include”, “comprise”, and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variations can be made without departing from the gist of the present disclosure.

### SUPPLEMENTARY NOTE

Features relating to the embodiments described above are described below as supplements.

### Supplementary Note 1

An image processing apparatus including;
a storage;
a communicator configured to be communicably connected to a terminal apparatus configured to save one or more files;
an image processor configured to perform image processing including printing;
a controller configured to control the image processor based on communication of the communicator;
a housing provided with the storage, the communicator, the image processor, and the controller; and
a mount mechanism configured to mount the terminal apparatus on the housing,
wherein when the controller receives a print operation for a first file saved in the terminal apparatus from a user while the terminal apparatus is mounted on the mount mechanism:
the controller causes the image processor to perform printing by the communicator receiving print data from the terminal apparatus when a second file the same as the first file is not saved in the storage, the print data being acquired by converting the first file into a data format suitable for printing; and
the controller causes the image processor to perform printing by the communicator receiving, from the terminal apparatus, a print instruction for instructing to print the second file instead of receiving the print data, when the second file is saved in the storage.

### Supplementary Note 2

The image processing apparatus according to supplementary note 1, wherein
the communicator is configured to receive a save request for saving the one or more files from the terminal apparatus, and
the controller performs processing of synchronization by saving, in the storage, a file that is not saved in the storage from among the one or more files, based on the save request.

### Supplementary Note 3

The image processing apparatus according to supplementary note 2, wherein
the controller starts the processing of synchronization when the terminal apparatus is mounted on the mount mechanism.

### Supplementary Note 4

The image processing apparatus according to supplementary note 2, wherein
when the terminal apparatus is mounted on the mount mechanism, the controller causes the terminal apparatus to display an inquiry whether to perform the processing of synchronization via the communicator.

### Supplementary Note 5

The image processing apparatus according to any one of supplementary notes 2 to 4, wherein
the communicator is capable of simultaneously communicating with a plurality of terminal apparatuses including the terminal apparatus, and
the controller performs the processing of synchronization individually with each of the plurality of terminal apparatuses.

### Supplementary Note 6

The image processing apparatus according to supplementary note 5, wherein
the communicator includes
a wired communicator configured to perform wired communication with one terminal apparatus mounted on the mount mechanism among the plurality of terminal apparatuses, and
a wireless communicator configured to perform wireless communication with another terminal apparatus among the plurality of terminal apparatuses, and
the controller performs the processing of synchronization with the one terminal apparatus via the wired communicator.

### Supplementary Note 7

The image processing apparatus according to supplementary note 5 or 6, wherein
when the image processor is caused to start the image processing by one terminal apparatus among the plurality of terminal apparatuses, the controller stops the processing of synchronization with another terminal apparatus among the plurality of terminal apparatuses.

### Supplementary Note 8

The image processing apparatus according to any one of supplementary notes 1 to 7, wherein
when the communicator receives the print data, the controller controls the image processor to perform the printing by using the print data, and
when the communicator receives the print instruction, the controller acquires the second file from the storage, converts the acquired second file into print data, and controls the image processor to perform the printing by using the print data.

### Supplementary Note 9

The image processing apparatus according to any one of supplementary notes 1 to 8, wherein
the communicator receives identification information indicating the first file from the terminal apparatus, and
the controller generates a notification indicating whether the second file is saved in the storage based on the identification information, and controls the communicator to transmit the notification to the terminal apparatus.

### Supplementary Note 10

The image processing apparatus according to supplementary note 2, wherein
the controller manages a folder individually created for each user,
the save request includes a user identifier for identifying a user, and
the controller saves a file in the storage in association with the folder of the user indicated by the user identifier.

### Supplementary Note 11

The image processing apparatus according to any one of supplementary notes 1 to 10, wherein the communicator includes:
a first communicator configured to perform wireless LAN communication; and
a second communicator configured to perform predetermined wireless communication in a narrower band than the wireless LAN communication,
the first communicator receives the print data from the terminal apparatus, and
the second communicator receives the print instruction from the terminal apparatus.

### Supplementary Note 12

The image processing apparatus according to any one of supplementary notes 1 to 11, wherein the controller controls the communicator to transmit a file saved on a side of the image processing apparatus to the terminal apparatus, and
the communicator receives print data acquired by processing the file and converting the processed file into a data format suitable for printing from the terminal apparatus.

### Supplementary Note 13

The image processing apparatus according to any one of supplementary notes 1 to 11, wherein
the controller controls the communicator to transmit a file saved at the image processing apparatus side to the terminal apparatus,
the communicator receives, from the terminal apparatus, process data representing content of a process performed on the file at the terminal apparatus side, and
the controller applies the process data to the file to generate a processed file, converts the processed file into print data, and controls the image processor to perform the printing using the print data.

### Supplementary Note 14

A terminal apparatus including:
a storage configured to store one or more files;
a communicator configured to be communicably connected to an image processing apparatus configured to perform image processing and including a housing including a mount mechanism configured to mount a terminal apparatus;
a display configured to display an operation screen for operating the image processing apparatus;
an operation inputter configured to receive an operation on the operation screen for printing a file selected by a user from among the one or more files; and
a controller configured to control the communicator to communicate with the image processing apparatus,
wherein when the controller receives a print operation for a first file saved in the storage from the user while the terminal apparatus is mounted on the mount mechanism:
the controller causes the image processing apparatus to perform printing by transmitting print data to the image processing apparatus via the communicator when a second file the same as the first file is not saved at the image processing apparatus side, the print data being acquired by converting the first file into a data format suitable for printing; and
the controller causes the image processing apparatus to perform printing by the communicator transmitting, to the image processing apparatus, a print instruction for instructing to print the second file instead of transmitting the print data, when the second file is saved at the image processing apparatus side.

### Supplementary Note 15

The terminal apparatus according to supplementary note 14, wherein
the controller controls the communicator to transmit identification information indicating the first file to the image processing apparatus in response to the operation inputter receiving an operation for printing the first file,
the communicator receives, from the image processing apparatus, a notification indicating whether the second file is saved on the side of the image processing apparatus, and
the controller determines whether the second file is saved at the image processing apparatus side based on the notification.

### Supplementary Note 16

A program causing a terminal apparatus to perform:
saving one or more files in a storage;
communicating with an image processing apparatus configured to perform image processing and including a housing including a mount mechanism configured to mount a terminal apparatus;
displaying an operation screen for operating the image processing apparatus;
receiving an operation on the operation screen for printing a file selected by a user from among the one or more files; and
when receiving a print operation for a first file saved in the storage from the user while the terminal apparatus is mounted on the mount mechanism:
causing the image processing apparatus to perform printing by transmitting print data to the image processing apparatus when a second file the same as the first file is not saved at the image processing apparatus side, the print data being acquired by converting the first file into a data format suitable for printing; and
causing the image processing apparatus to perform printing by transmitting, to the image processing apparatus, a print instruction for instructing to print the second file instead of transmitting the print data when the second file is saved at the image processing apparatus side.

### Supplementary Note 17

A printing system including:
the image processing apparatus according to supplementary note 1; and
the terminal apparatus according to supplementary note 14.

### Supplementary Note 18

An image processing apparatus including;
a storage configured to save files;
a communicator configured to be communicably connected to a terminal apparatus saving files;
an image processor configured to perform image processing including printing;
a controller configured to control the image processor based on communication of the communicator;
a housing provided with the storage, the communicator, the image processor, and the controller; and
a mount mechanism configured to mount the terminal apparatus on the housing,
wherein when the controller receives a print operation for a target file from a user of the terminal apparatus while the terminal apparatus is mounted on the housing:
the controller causes the image processor to perform printing by the communicator receiving print data from the terminal apparatus when the target is saved in the terminal apparatus, the print data being acquired by converting the target file into a data format suitable for printing, and
the controller causes the image processor to perform printing by receiving, from the terminal apparatus, a print instruction for instructing to print the target file instead of receiving the print data when the target file is saved in the storage.

### REFERENCE SIGNS

1: Printing system
22: Operation panel
26: Sheet feed tray
27: Sheet discharge tray
28: Document table cover
29: Document table
100: Terminal apparatus
101: Communicator
101a: Wireless LAN communicator
101b: NFC communicator
101c: USB communicator
102: Display
103: Operation inputter
104: Touch panel display
105: Controller
106: Storage
110: Bus
150: Housing
200: Image processing apparatus
201: Communicator
201a: Wireless LAN communicator
201b: NFC communicator
201c: USB communicator
202: Image processor
202a: Printing device
202b: Scanner
202c: Public network communicator
203: Controller
204: Storage
210: Bus
221: Mount mechanism
221a: NFC antenna
221b: Holding part
221c: Holding part
221d: Connection terminal
221e: Holding part
221f: Holding part
250: Housing

1. An image processing apparatus comprising;
a storage;
a communicator configured to be communicably connected to a terminal apparatus configured to save one or more files;
an image processor configured to perform image processing comprising printing;
a controller configured to control the image processor based on communication of the communicator;
a housing provided with the storage, the communicator, the image processor, and the controller; and
a mount mechanism configured to mount the terminal apparatus on the housing,
wherein when the controller receives a print operation for a first file saved in the terminal apparatus from a user while the terminal apparatus is mounted on the mount mechanism:
the controller causes the image processor to perform printing by the communicator receiving print data from the terminal apparatus when a second file the same as the first file is not saved in the storage, the print data being acquired by converting the first file into a data format suitable for printing; and
the controller causes the image processor to perform printing by the communicator receiving, from the terminal apparatus, a print instruction for instructing to print the second file instead of receiving the print data, when the second file is saved in the storage.

2. The image processing apparatus according to claim 1, wherein
the communicator is configured to receive a save request for saving the one or more files from the terminal apparatus, and
the controller performs processing of synchronization by saving, in the storage, a file that is not saved in the storage from among the one or more files, based on the save request.

3. The image processing apparatus according to claim 2, wherein
the controller starts the processing of synchronization when the terminal apparatus is mounted on the mount mechanism.

4. The image processing apparatus according to claim 2, wherein
when the terminal apparatus is mounted on the mount mechanism, the controller causes the terminal apparatus to display an inquiry whether to perform the processing of synchronization via the communicator.

5. The image processing apparatus according to claim 2, wherein
the communicator is capable of simultaneously communicating with a plurality of terminal apparatuses comprising the terminal apparatus, and
the controller performs the processing of synchronization individually with each of the plurality of terminal apparatuses.

6. The image processing apparatus according to claim 5, wherein
the communicator comprises:
a wired communicator configured to perform wired communication with one terminal apparatus mounted on the mount mechanism among the plurality of terminal apparatuses; and
a wireless communicator configured to perform wireless communication with another terminal apparatus among the plurality of terminal apparatuses, and
the controller performs the processing of synchronization with the one terminal apparatus via the wired communicator.

7. The image processing apparatus according to claim 5, wherein
when the image processor is caused to start the image processing by one terminal apparatus among the plurality of terminal apparatuses, the controller stops the processing of synchronization with another terminal apparatus among the plurality of terminal apparatuses.

8. The image processing apparatus according to claim 1, wherein
when the communicator receives the print data, the controller controls the image processor to perform the printing by using the print data, and
when the communicator receives the print instruction, the controller acquires the second file from the storage, converts the acquired second file into print data, and controls the image processor to perform the printing by using the print data.

9. The image processing apparatus according to claim 1, wherein
the communicator receives identification information indicating the first file from the terminal apparatus, and
the controller generates a notification indicating whether the second file is saved in the storage based on the identification information, and controls the communicator to transmit the notification to the terminal apparatus.

10. The image processing apparatus according to claim 2, wherein
the controller manages a folder individually created for each user,
the save request comprises a user identifier for identifying a user, and
the controller saves a file in the storage in association with the folder of the user indicated by the user identifier.

11. The image processing apparatus according to claim 1, wherein
the communicator comprises:
a first communicator configured to perform wireless LAN communication; and
a second communicator configured to perform predetermined wireless communication in a narrower band than the wireless LAN communication,
the first communicator receives the print data from the terminal apparatus, and
the second communicator receives the print instruction from the terminal apparatus.

12. The image processing apparatus according to claim 1, wherein
the controller controls the communicator to transmit a file saved on a side of the image processing apparatus to the terminal apparatus, and
the communicator receives print data acquired by processing the file and converting the processed file into a data format suitable for printing from the terminal apparatus.

13. The image processing apparatus according to claim 1, wherein
the controller controls the communicator to transmit a file saved at the image processing apparatus side to the terminal apparatus,
the communicator receives, from the terminal apparatus, process data representing content of a process performed on the file at the terminal apparatus side, and
the controller applies the process data to the file to generate a processed file, converts the processed file into print data, and controls the image processor to perform the printing using the print data.

14. A terminal apparatus comprising:
a storage configured to save one or more files;
a communicator configured to be communicably connected to an image processing apparatus configured to perform image processing and comprising a housing comprising a mount mechanism configured to mount a terminal apparatus;
a display configured to display an operation screen for operating the image processing apparatus;
an operation inputter configured to receive an operation on the operation screen for printing a file selected by a user from among the one or more files; and
a controller configured to control the communicator to communicate with the image processing apparatus,
wherein when the controller receives a print operation for a first file saved in the storage from the user while the terminal apparatus is mounted on the mount mechanism:
the controller causes the image processing apparatus to perform printing by transmitting print data to the image processing apparatus via the communicator when a second file the same as the first file is not saved at the image processing apparatus side, the print data being acquired by converting the first file into a data format suitable for printing; and
the controller causes the image processing apparatus to perform printing by the communicator transmitting, to the image processing apparatus, a print instruction for instructing to print the second file instead of transmitting the print data, when the second file is saved at the image processing apparatus side.

15. The terminal apparatus according to claim 14, wherein
the controller controls the communicator to transmit identification information indicating the first file to the image processing apparatus in response to the operation inputter receiving an operation for printing the first file,
the communicator receives, from the image processing apparatus, a notification indicating whether the second file is saved on the side of the image processing apparatus, and
the controller determines whether the second file is saved at the image processing apparatus side based on the notification.

16. A printing system comprising:
the image processing apparatus according to claim 1; and
the terminal apparatus.

17. An image processing apparatus comprising;
a storage configured to save files;
a communicator configured to be communicably connected to a terminal apparatus saving files;
an image processor configured to perform image processing comprising printing;
a controller configured to control the image processor based on communication of the communicator;
a housing provided with the storage, the communicator, the image processor, and the controller; and
a mount mechanism configured to mount the terminal apparatus on the housing,
wherein when the controller receives a print operation for a target file from a user of the terminal apparatus while the terminal apparatus is mounted on the housing:
the controller causes the image processor to perform printing by the communicator receiving print data from the terminal apparatus when the target is saved in the terminal apparatus, the print data being acquired by converting the target file into a data format suitable for printing, and
the controller causes the image processor to perform printing by receiving, from the terminal apparatus, a print instruction for instructing to print the target file instead of receiving the print data when the target file is saved in the storage.
